(19) United States
(12) Patent Application Publication
(10) Pub. No.: US 2022/0342956 A1
(43) Pub. Date: Oct. 27, 2022

(54) SYSTEMS AND METHODS FOR REMOVING SYSTEMIC BIAS

(71) Applicant: Anthony Bastick, Great Missenden (GB)

(72) Inventor: Anthony Bastick, Great Missenden (GB)

(21) Appl. No.: 17/639,902

(22) PCT Filed: Sep. 4, 2020
(86) PCT No.: PCT/GB2020/052126

§ 371 Date: Mar. 2, 2022

Related U.S. Application Data
(60) Provisional application No. 62/895,580, filed on Sep. 4, 2019.

(51) Int. Cl. G06F 17/18; G06K 9/62; G06F 17/12

(52) U.S. Cl. CPC G06F 17/18; G06K 9/6218; G06F 17/12

(57) ABSTRACT

Disclosed herein are system, method, and computer program product embodiments that generally relate to systems and methods of removing systemic bias in a single datum and in data sets. Embodiments include systems and methods of data processing for data related to meter responses, and also to systems and methods of data processing of attitudinal data and/or analysis of questionnaire response(s), as well as systems and methods of processing and analysing statistical data, each of which can be affected by systemic bias.

### BACKGROUND

### Technical Field

Embodiments generally relate to systems and methods of removing systemic bias in a single datum and in data sets. Aspects may be directed to systems and methods of processing of single event meter readings, attitudinal data and/or analysis of questionnaire responses, and also to systems and methods of processing for statistical data analysis, each of which can be affected by systemic bias. Further aspects may include systems and methods of processing data related to meter responses.

### Background

Prior designs have been unable to identify systemic (non-random) components of single signals from a system. As a ‘convenient’ work-around, they have assigned this unknown but expected and repeatable patten to a random error component of the signal. This has been succinctly described as R=T+e, where ‘R’ is a Recorded measurement of a system signal, ‘T’ is the True measurement of the signal and ‘e’ is a random error in the recorded measurement of the signal. Further, arithmetically convenient ‘one-size-fits-all’ assumptions are made about the type of randomness of the error that enable an average True measure to be derived of a group of signals. Commonly, the so called random errors are assumed (i) to be independent between signals (e.g. no learning or other feedback from the receiving environment to the signal source), (ii) assumed to have a fixed variation (e.g. large signals have the same proportion of random error as small signals) and (iii) it is assumed that the errors are symmetrical about zero error (e.g. no tendency to ‘over shoot’ or ‘under shoot’). Yet, despite assumptions denying all these functions of ‘natural’ systems responding to their environment, there is a contradictory fourth assumption that (iv) the errors follow a Normal growth and decay distribution typical of natural systems within their environment. However, the arithmetic convenience of these limiting assumptions is that for large numbers of such limited signals the mean of the errors will, by definition of the assumptions, tend to zero. In practice, averaging large numbers of these limited signals will average out the errors so that with increasing numbers the errors in the estimated average of the group will tend to zero, The group result of these analyses are then assumed to applied to each signal in the group to the extent that the signal is similar to the mean of the large group signals that has been selected for averaging. This venerable theory of signal response ‘R=T+e’ is referred to a ‘Classical Response Theory’ or sometimes “True Score Theory’.

The extensive applications that use these prior methods and systems have numerous problems. Clearly no ‘natural system’ that is ‘fit-for-purpose’ can emanate a signal that fulfils the conflicting natural and unnatural assumptions of this prior design. Further, each signal of a natural system, at a more precise level of description, will be a compound signal and the most common compound signals characteristic of natural systems might not tend to a mean (e.g. different samples of a compound signal that are composed as the ratio of two Normal signals will not tend to a single mean no matter how large or many are the sample signals that are averaged). Apart from producing high precision invalid results to the extent that the signals cannot fit the assumptions, there is the large cost of large numbers that are needed to reduce the error to acceptably near zero. Then, the biggest disadvantage of all, it that the ‘average’ result does not apply accurately to any individual signal. Worse, the more signals that are used to reduce the group error to zero, then the more variation there will be (i.e. assumed error) between the any single and the average signal for the group.

An example of this paradox is the desired application of ‘Personal medicine’—increasing numbers of patients are needed as ‘signal sources’ to reduce the group error to zero. But, as the numbers of patients increase, the group result applies less and less to each and any individual patient. The ideal concept of having a result that applies more precisely to the individual patient has been renamed ‘Personal medicine’. But as it is unattainable under the previous R=T+e design, it has been renamed as ‘precision medicine’. But this is still a paradox as it requires finding large enough groups of patients who are so very similar to each other that their differences from their group mean will be close to zero. Using patients—if every signal was the same (which is not the case) then a sample of only one would tell us the size of every signal. Another problem is that, sometimes, it is not desirable to want to remove the system bias. Rather, the system bias is the focus of interest. For example, marketing ‘treatments’ i.e. advertising, can direct costumers (systems) expectation to the profile of a given product. Similarly, changing patients' systemic expectations before an operation can improve healing. Another common example were systemic system expectations are utilised is in Patriotic campaigns for cheaply increasing citizen (systems) satisfaction by lower citizen (systems) expectations, rather than supplying costly services to reach the same levels of citizen satisfaction.

By assigning systemic bias to random error and then reducing the error to zero, known methods and systems are destroying systemic bias. However, systemic bias is an obvious component of the datum that links the individual signal to its source. This is why prior methods and systems produce only group results that have reduced error and no special relevance to the individual system sources of the signals.

The prior design destroys the individuality of the source marker for each signal, replacing each individual source by a notional ‘group mean’ system that itself notionally produced all the varied signals. Thus, reducing the individuality of each source so it is not possible, when using the prior methods and systems, to easily distinguish which system was the source of each signal. This less discriminating group description given by the prior design, is a ‘higher order’ description, stereotyping the individual system sources in the group e.g. the description of an illness rather than how individuals differently experience the illness.

In a more specific field, psychometrics is a field of study that develops methods and techniques of psychological measurement. The field is concerned with the objective measurement of psychological traits such as, for example, skills, knowledge, abilities, attitudes, personality traits, and educational achievement. Some psychometric researchers focus on the construction and validation of assessment instruments such as questionnaires, tests, raters' judgments, and personality tests. Others focus on research relating to measurement theory (e.g., item response theory; intraclass correlation).

Psychometrics is further applied to objectively measure attitudinal responses from persons, such as those related to their feelings, perception, likes, dislikes, interests and preferences. For example, psychometrics can be applied in the medical field to objectively diagnose diseases by asking attitudinal questions (e.g., level of pain or discomfort, severity of symptoms, etc.). In particular, core outcome sets (COS) are standardized collections of questions and results that are measured and reported in relation to an area of health or disease. Attitudinal scales are used to measure constructs that are the focus of the questions (e.g., “what is your pain from 1-10?”, “what is your level of fatigue from 1 to 5?”, etc.). These data can be used for any number of purposes, for example, diagnoses, research studies, discovering groups and correlations, etc.

A core problem with attitudinal questionnaires is that they commonly have low demonstrable accuracy. People's expectations of a construct will vary drastically based on any number of factors such as past experiences, culture, present emotional state, etc. For example, two persons experiencing the exact level of pain stimulus may assign very different numbers to their experienced level of the pain (e.g., one person may say his pain is a 5 out of 10 and the other a 9 out of 10). While psychometric methods and techniques exist to compensate for each respondent's expectations, further work is needed to improve attitudinal scale accuracy and obtain more useful data from respondents.

Records of system response outcomes are used to explore for, or to target, characteristics/profiles/signatures (CPSs) of the systems that produced them. A system may be any construct (physical, psychological, cultural, biological, etc.) that produces measurable responses to a stimulus or other measurement. One example of a system may be a disease in a person, and the responses to a stimulus may be the person's responses to questions. Another example of a system may be a material being analyzed by a mass spectrometer, with the response outcomes being the measured mass-to-charge ratio of ions subjected to magnetic or electric fields. The response outcomes of these systems may produce identifiable characteristics or signatures that may be useful in understanding the systems and identifying their presence.

Analyzing CPSs generally involves data analysis including factor or component analysis and clustering techniques. However, many of these methods confound the identification of a system with the strength or magnitude of the system responses. This may lead the system identification to fail when the magnitude of the system responses is low (e.g., a disease may not be detected on its early stages). Furthermore, many systems may share response outcomes, and adding response outcomes may not provide meaningful results. For example, a medical questionnaire may result in a diagnosis covering multiple potential diseases with a high level or uncertainty.

### BRIEF DESCRIPTION OF THE DRAWINGS

The accompanying drawings are incorporated herein and form a part of the specification.

FIG. 1 shows a flow diagram illustrating a method of collecting and scaling attitudinal questionnaire data to account for respondent expectation, according to particular example embodiments.

FIG. 2 shows a flowchart for a method for identifying sub-construct groups from attitudinal response data, according to particular example embodiments.

FIG. 3 shows a dendogram illustrating clustering of respondents data, according to particular example embodiments.

FIG. 4 sample data for performing a method for identifying sub-construct groups from attitudinal response data, according to particular example embodiments.

FIG. 5 illustrates a questionnaire system environment, according to particular example embodiments.

FIG. 6 is an example computer system useful for implementing various embodiments.

FIGS. 7a and 7b are conceptualized representations of theoretical systems that are empirically testable through analysis of their single signal expectation biases.

FIG. 8 shows three components systems that produce recorded data in one example.

### DETAILED DESCRIPTION

Provided herein are system, method and/or computer program product embodiments, and/or combinations and sub-combinations thereof, for removing systemic bias in data sets. Additionally, provided herein are system, method and/or computer program product embodiments, and/or combinations and sub-combinations thereof, for (a) performing attitudinal scaling and/or analysis of questionnaire responses and/or (b) data processing for statistical data analysis, each of which can be affected by systemic bias. While the embodiments described herein are exemplified in the context of a computerized assessment and analysis of respondent data, they are generally applicable to any systems and methods that employ systems' response data.

The present invention provides a method for recalibrating a system signal to identify, measure and/or manage systemic bias, the method comprising the steps of: (a) define context appropriate response theories that partition systemic error ‘E’ differently from random error ‘e’, described as R=f(T, E, e), where ‘E’ is system expectation bias and ‘e’ is a random error; (b) measure one or more reference responses within a set context where the ‘E’ values are constant using at least as many reference signals as there are unknown E values, (c) input a target signal to be recalibrated, (d) determine, using the responses to the reference signals, the ‘E’ values giving a formula for calculating R in the set context, (e) determine the most appropriate response theories from a selection of given response theories, and (f) recalibrate the target signal using the selected response theory.

The method may be implemented on a computer having at least one processor.

The response theory may be a function comprising at least one of: a multiplication or division operation, an exponent or logarithmic operation, or simultaneous equations.

The set context may comprise a presentation of a stimulus comprising at least one of an image, a video, an audio, a text, a smell, a taste, and a feeling. Alternatively and/or additionally, the set context comprises a presentation of a vignette, a celebrity, a personification, or a brand image. Alternatively and/or additionally, the set context may comprise a standard stimulus applied to the respondent.

In step (a), R may represent a Response signal recorded by a computer, T may represent the True unbiased component of the signal as sent by the source system(s) and f may be a function describing how each of these three components of the Recorded signal have been elaborated and combined to result in the recorded response signal R.

The method may further comprise, in step (b), determining the most appropriate response theory(s) from a selection of given response theories.

The method may further comprise, in step (c), receiving Recorded response(s) R that correspond to one or more known perturbative true reference signals T within a set context where the ‘E’ values are constant, using at least as many reference signals as there are unknown E values in the most appropriate response theory(s) from step (b).

The method may further comprise, in step (d), receiving a Record of the response to an unknown perturbative target signal T within the same set context where the ‘E’ values are constant.

The method may further comprise, in step (e), determining the ‘E’ values giving a formula or formulae for calculating R in the set context, for the most appropriate response theory(s) from step (b), using the responses from step (c) to the reference signals.

The method may further comprise, in step (f), recalibrating the response from step (d), using the formula or formulae for calculating R in the set context from step (e), to calculate/reveal the true value of the previously unknown perturbative target signal T received in step (d).

The method may further comprise repeating step (d) using the same perturbative target signal T in the set context, to use the variation in the corresponding R values and/or corresponding recalibrated values from (f) to check the consistency of the context where the ‘E’ values are required to be constant.

Also provided is a system comprising: a memory and at least one processor coupled to the memory and configured to: (a) define context appropriate response theories that partition systemic error ‘E’ differently from random error ‘e’, described as R=f(T, E, e), where ‘E’ is system expectation bias that in previous designs is included with ‘e’ described as having properties giving arithmetic ‘convenience’; (b) measure one or more reference responses within a set context where the ‘E’ values are constant using at least as many reference signals as there are unknown E values, (c) input a target signal to be recalibrated, (d) determine, using the responses to the reference signals, the ‘E’ values giving a formula for calculating R in the set context, (e) determine the most appropriate response theories from a selection of given response theories, and (f) recalibrate the target signal using the selected response theory.

The processor may be additionally configured to carry out the steps of any of the steps above.

Also provide is a tangible computer-readable device having instructions stored thereon that, when executed by at least one computing device, causes the at least one computing device to perform operations comprising: (a) define context appropriate response theories that partition systemic error ‘E’ differently from random error ‘e’, described as R=f(T, E, e), where ‘E’ is system expectation bias that in previous designs is included with ‘e’ for arithmetic ‘convenience’, (b) measure one or more reference responses within a set context where the ‘E’ values are constant using at least as many reference signals as there are unknown E values, (c) input a target signal to be recalibrated, (d) determine, using the responses to the reference signals, the ‘E’ values giving a formula for calculating R in the set context, (e) determine the most appropriate response theories from a selection of given response theories, and (f) recalibrate the target signal using the selected response theory.

The instructions may further cause the at least one computing device to perform operations comprising the steps of any of the above steps.

Also provide is a computer-implemented method comprising, by at least one processor: receiving a first attitudinal response from a respondent, the first response assigning a numerical measurement to a construct with respect to a public object; receiving a second attitudinal response from the respondent, the second response assigning a numerical measurement to the construct with respect to the respondent, wherein the first and second responses respond to questions asked in a manner that maintains the same expectation; retrieving an attitudinal response scaling function, wherein the function assigns a first response value based on one or more scaling operations where an expectation value acts on a value of the construct that is independent of the expectation; computing a scaling factor that is independent of the expectation value by reversing and combining each of the one or more scaling operations applied to the first and second attitudinal responses; computing an output value by reversing each of the one or more reversed scaling and combining operations applied to the scaling factor and a gold-standard value associated with the public object so as to have the second attitudinal response remain unmodified when the first attitudinal response is the same as the gold-standard value; and storing the output value as a datum for measuring the construct with respect to the respondent.

“Attitudinal response” may, amongst others, include any form of response from a person to an external stimulus including opinions and/or physical responses that require a degree of interpretation such as quantifying the level of pain or discomfort someone experiences, or the how some other external stimulus is considered by the respondent.

The response scaling function may comprise at least one of a multiplication operation and an exponent operation.

The computing the scaling factor by reversing and combining each of the one or more scaling operations may comprise combining the reversed scaling operations with a division operation.

The construct may comprise a feeling including discomfort or pain. The construct may comprise a social-cultural identity named from one or more behaviors or states including at least one of a teacher, musician, consumer, schizophrenic, and victim.

The public object may comprise a presentation of a stimulus comprising at least one of an image, a video, an audio, a text, a smell, a taste, and a feeling.

The public object may comprise a visual presentation showing a vignette, a celebrity, a personification, or a brand image. The public object may comprise a standard physical stimulus applied to the respondent.

The first attitudinal response may comprise an aggregation of a plurality of attitudinal responses assigning a numerical value to the construct with respect to the public object under the same expectation, and the second attitudinal response may comprise an aggregation of a plurality of attitudinal responses assigning a numerical value to the construct with respect to the respondent under the same expectation.

The first and second responses may comprise one of a plurality of pairs of responses, and wherein the computing an output value comprises computing an output value for each of the plurality of pairs of responses.

Also provided is a system, comprising: a device providing a public object experience; and a memory and at least one processor coupled to the memory and configured to: receive a first attitudinal response from a respondent, the first response assigning a numerical measurement to a construct with respect to the public object experience; receive a second attitudinal response from the respondent, the second response assigning a numerical measurement to the construct with respect to the respondent, wherein the first and second responses respond to questions asked in a manner that maintains the same expectation; retrieve an attitudinal response scaling function, wherein the function assigns a first response value based on one or more scaling operations where an expectation value acts on a value of the construct that is independent of the expectation; compute a scaling factor that is independent of the expectation value by reversing and combining each of the one or more scaling operations applied to the first and second attitudinal responses; compute an output value by reversing each of the one or more reversed scaling and combining operations applied to the scaling factor and a gold-standard value associated with the public object so as to have the second attitudinal response remain unmodified when the first attitudinal response is the same as the gold-standard value; and store the output value as a datum for measuring the construct with respect to the respondent.

The public object device may comprises a video or audio playback device presenting an experience of the construct, a device that applies a physical stimulus to the respondent. The physical stimulus may comprise an electric shock to the respondent's body.

The at least one processor may be further configured to send the first and second responses through a communications network to a remote server.

The system may further comprise a display device; and an input interface, wherein the at least one processor is further configured to: receive the first and second responses through the input interface, and display the output value on the display device.

The at least one processor may be further configured to: display at least one of an average and an accuracy of the output value.

Also provided is a tangible computer-readable device having instructions stored thereon that, when executed by at least one computing device, causes the at least one computing device to perform operations comprising: receiving a first attitudinal response from a respondent, the first response assigning a numerical measurement to a construct with respect to a public object; receiving a second attitudinal response from the respondent, the second response assigning a numerical measurement to the construct with respect to the respondent, wherein the first and second responses respond to questions asked in a manner that maintains the same expectation; retrieving an attitudinal response scaling function, wherein the function assigns a first response value based on one or more scaling operations where an expectation value acts on a value of the construct that is independent of the expectation; computing a scaling factor that is independent of the expectation value by reversing and combining each of the one or more scaling operations applied to the first and second attitudinal responses; computing an output value by reversing each of the one or more reversed scaling and combining operations applied to the scaling factor and a gold-standard value associated with the public object so as to have the second attitudinal response remain unmodified when the first attitudinal response is the same as the gold-standard value; and storing the output value as a datum for measuring the construct with respect to the respondent.

The response scaling function may comprise at least one of a multiplication operation and an exponent operation.

The computing the scaling factor by reversing and combining each of the one or more scaling operations may comprise combining the reversed scaling operations with a division operation.

Also provided is a computer-implemented method comprising, by at least one processor: receiving a data set comprising outputs from a plurality of samples, the data set comprising a matrix of vectors where each vector holds same-ordered outputs for each sample; determining two or more indices from the matrix; computing an average for each of the indices from the matrix; computing a plurality of ratios of the averages for each pair of indices, each of the plurality of ratios being less than or equal to 1; computing a variance for each of the plurality of ratios across the plurality of samples; determining a smallest one of the computed variances; and categorizing samples by clustering the plurality of samples into a plurality of clusters based on their particular values of the ratio corresponding to the determined smallest one of the computed variances.

The method may further comprise: receiving a second plurality of outputs from the plurality of samples; and categorizing each of the second plurality of output into the plurality of clusters.

The determining one or more indices may comprise determining one or more principal factors of the plurality of the matrix of vectors using statistical factor analysis or a non-rescaled/non-standardized equivalent.

41. The method of any of claims 38 to 40, wherein the determining one or more principal factors comprises performing a varimax rotation of the matrix of vectors.

42. The method of any of claims 38 to 41, wherein the clustering the plurality of samples comprises performing centroid hierarchical clustering with a squared Euclidian metric.

43. The method of any of claims 38 to 42, wherein the outputs comprise responses to questions and the samples comprise respondents to the questions.

44. The method of any of claims 38 to 43, wherein each vector holds pairs of responses to a plurality of questions, the first response of a pair comprising a response to a question with respect to a public object and the second response of the pair comprising a response to the question with respect to the respondent.

Also provided is a system, comprising: a memory and at least one processor coupled to the memory and configured to: receive a data set comprising outputs from a plurality of samples, the data set comprising a matrix of vectors where each vector holds same-ordered outputs for each sample; determine two or more indices from the matrix; compute an average for each of the indices from the matrix; compute a plurality of ratios of the averages for each pair of indices, each of the plurality of ratios being less than or equal to 1; compute a variance for each of the plurality of ratios across the plurality of responses; determine a smallest one of the computed variances; and categorize respondents by clustering the plurality of samples into a plurality of clusters based on their particular values of the ratio corresponding to the determined smallest one of the computed variances.

The system may further comprise receiving a plurality of outputs from a second plurality of samples; and categorizing each of the second plurality of samples into the plurality of clusters.

The determining one or more indices may comprise determining one or more principal factors of the plurality of the matrix of vectors using statistical factor analysis.

The determining one or more principal factors may comprise performing a varimax rotation of the matrix of vectors.

The clustering the plurality of respondents may comprise performing centroid hierarchical clustering with a squared Euclidian metric.

The outputs may comprise responses to questions and the samples comprise respondents to the questions.

Each vector may hold pairs of responses to a plurality of questions, the first response of a pair comprising a response to a question with respect to a public object and the second response of the pair comprising a response to the question with respect to the respondent.

Also provided is a tangible computer-readable device having instructions stored thereon that, when executed by at least one computing device, causes the at least one computing device to perform operations comprising: receiving a data set comprising outputs from a plurality of samples, the data set comprising a matrix of vectors where each vector holds same-ordered outputs for each sample; determining two or more indices from the vectors; computing an average for each of the indices from the matrix; computing a plurality of ratios of the averages for each pair of indices, each of the plurality of ratios being less than or equal to 1; computing a variance for each of the plurality of ratios across the plurality of responses; determining a smallest one of the computed variances; and categorizing respondents by clustering the plurality of samples into a plurality of clusters based on their particular values of the ratio corresponding to the determined smallest one of the computed variances.

The operations may further comprise receiving a plurality of outputs from a second plurality of samples; and categorizing each of the second plurality of samples into the plurality of clusters.

The determining one or more indices may comprise determining one or more principal factors of the plurality of the matrix of vectors using statistical factor analysis.

The determining one or more principal factors may comprise performing a varimax rotation of the matrix of vectors.

The clustering the plurality of respondents may comprise performing centroid hierarchical clustering with a squared Euclidian metric.

The outputs may comprise responses to questions and the samples comprise respondents to the questions.

Each vector may hold pairs of responses to a plurality of questions, the first response of a pair comprising a response to a question with respect to a public object and the second response of the pair comprising a response to the question with respect to the respondent.

The features of any particular aspect described above may be combined with a different aspect of the invention.

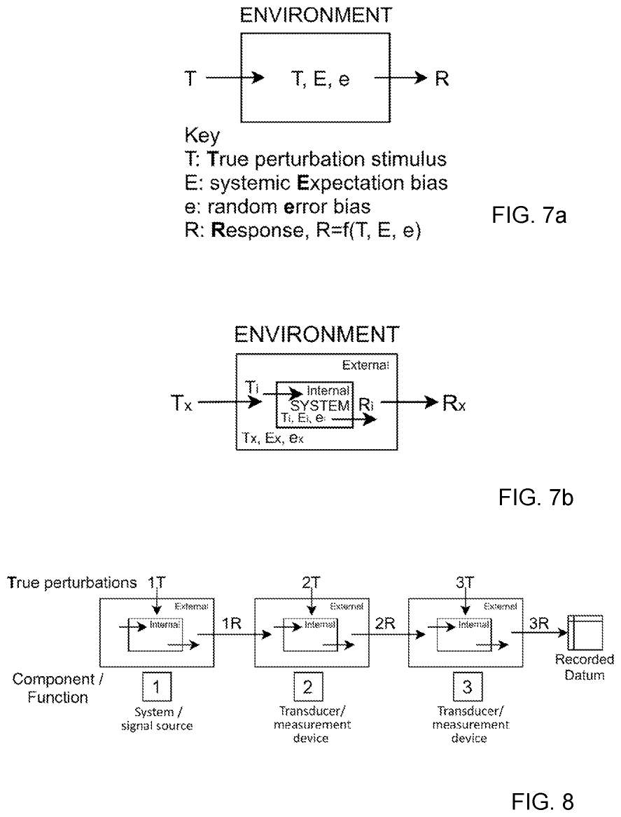

The present invention is illustrated in the broadest sense in FIGS. 7a, 7b and 8 and is described in the following.

By using (a) reference stimuli and (b) assumed response theory(s) of biases, this method can (i) validate the theory(s) and/or (ii) correct for systemic response biases.

Broadly speaking, the invention recalibrates system signals to identify, measure and manage systemic biases. It does this by (a) defining context appropriate response theories that partition systemic error ‘E’ differently from random error ‘e’, described as R=f(T, E, e), where ‘E’ is system expectation bias that in previous designs is included with ‘e’ for arithmetic ‘convenience’. Then (b) it measures reference responses within a set context where the ‘E’ values are constant (using at least as many reference signals as there are unknown E values). Then, (c) it inputs a target signal that is to be recalibrated. Then (d) it uses the responses to the reference signals to determine the ‘E’ values giving a formula for calculating R in the that context. It can then check the response theory (RT), choose the best RT from a selection of given RTs. And then (e) uses the best response theory or theories to recalibrate the target signal. This is known by the applicant as BCD—the letters are not an acronym, but simply the applicant's choice.

In step (a), R may represent a Response signal recorded by a computer, T may represent the True unbiased component of the signal as sent by the source system(s) and f may be a function describing how each of these three components of the Recorded signal have been elaborated and combined to result in the recorded response signal R.

In step (b), the most appropriate response theory(s) may be determined from a selection of given response theories.

In step (c), Recorded response(s) R may be received, the responses corresponding to one or more known perturbative true reference signals T within a set context where the ‘E’ values are constant, using at least as many reference signals as there are unknown E values in the most appropriate response theory(s) from step (b).

In step (d), a Record of the response to an unknown perturbative target signal T within the same set context where the ‘E’ values are constant may be received.

In step (e), using the responses from step (c) to the reference signals, the ‘E’ values giving a formula or formulae for calculating R in the set context, for the most appropriate response theory(s) from step (b), may be determined.

In step (f), the response from step (d) may be recalibrated, using the formula or formulae for calculating R in the set context from step (e), to calculate/reveal the true value of the previously unknown perturbative target signal T received in step (d).

Step (d) may be repeated using the same perturbative target signal T in the set context, to use the variation in the corresponding R values and/or corresponding recalibrated values from (f) to check the consistency of the context where the ‘E’ values are required to be constant. The repetition of step (d) may be after a response is received under step (d) above (i.e. step (d) is repeated one or more times before step (e) is done), as if the variation in the context is unacceptable, then an error message can be output to that effect so that recuperative action can be taken at this stage (e,g, fix the cause of the variation and start again). Alternatively or additionally, it may be repeated at a different stage, such as after all calculations are done because the RTs transforms might also acceptably transform the variation.

### Advantages

One or more of the technical advantages provided by the various aspects of the invention depend on the purposes of their applications. These are derived initially from and partitioning, identifying and measuring of the causes of variation contained in a recorded system signal (in the singular) into three attributed source categories, being the True system signal, Expected biases and random error. Applications might receive technical advantages from having these three components recognized and quantified. Such advantages include (i) being able to empirically test assumed theoretical descriptions (Response Theories) for systemic structural causes from system signal components; (ii) recalibrate (clean) recorded signals to isolate these structural biases. For example, in some applications there might be an interest in the True ‘objective’ component so then re-calibration can remove the Expectation biases. This is the case in medical applications of the attitudinal measurement embodiment. The random errors in the resulting cleaned data can be identified and used or removed through the actions of current research designs (e.g. averaging the cleaned data). In other applications of this same embodiment, there might be an interest in the ‘subjective’ Expectation biases. These can also be made into ‘objective’ measures by re-calibration, as in influencing applications for compliance with medical treatments (therapies), or role/identity change treatments psychologists and/or psychiatrists would use for enabling a person to be more functional in a wider range of social environments. Correspondingly in the meter embodiment, the invention allows different optimum Response Theories to be automatically switched-in by environmental sensors so that the same meter can be used in wider ranges of working environments outside of the current previously recommended meter working environments of temperature, voltage, humidity, etc. This includes greater ranges of internal environments avoiding such frequent factory returns for maintenance, battery power reduction, even model upgrades.

In all subsequent applications that use the ‘cleaned’ data components in place of the prior data components, fewer data examples are required for the same levels of significance and effect sizes. The technical effect is a large saving on processing resources. In the Attitudinal measure embodiment this translates to fewer questions on questionnaires and fewer respondents answering questions. For medical questionnaires, this complies with requirements for reduced patient burden, cheaper storage of less data and faster processing of the smaller datasets required. Alternatively, the advantages can be leveraged to produce results of greater significance and effect size with the same size datasets as are funded under the previous Classical Response Theory R=T+e, but now using the data described by the invention R=f(T, E, e) in the first instance and to even greater effect where T is an optimally precise MVR True Response in the second instance.

In addition the MVR is such a sensitive and precise species-relative single signal marker that it not only recognizes the species of the signaling system using much weaker signals than needed by previous designs, but it also opens the possibility of identifying the existence of new species of signal systems that can then be further investigated using alternative environmental markers derived from increased partitioning under local hierarchal clustering. For example, it could find that the coronavirus infecting males is a different species from that infecting females. The different male vs female environments that best and differently support these two species can be used to find gender specific cures for the virus that would be more effect than gender indifferent cures.

The use of the R=f(T, E, e) principle explained above offers new theoretical causal descriptions of systems that are empirically testable through analysis of their single signal expectation biases. This is shown in FIGS. 7a and 7b.

This invention alternatively reduces the systemic error for single system signals. So it allows therefore for personal medicine. It is more cost effective by avoiding ‘large sample sizes’ needed by the prior design for error reduction. To generate and understand these response theories, it helps to conceptualize each system as having an internal and external environment as illustrated in FIG. 7a.

A preferred understanding is that the system's internal environmental signals are determined by and serve its evolutionary fitness/strength. Its external environmental signals are determined by its contextual purpose. The system in context is thus best understood as a sentient conceptual object, that is, as one contextualized identity of the system, whose signals are its ‘behaviours’ serving its purposes in its current context. It can be assumed that the existence of a recorded signal Rx means that the system is, to some extent, fit for purpose i.e. it has the strength to have produced a signal for its purpose in its context.

Systems can be conceptualized in terms of combinations of specialized component systems. However, each time a signal crosses a conceptual environmental ‘boundary’ its own R=f(T, E, e) directional boundary response theory applies.

So, for example, a recorded signal datum can be conceptualized as being processed through three system components. The invention inputs such recorded data. This data represents transponder output corresponding to measured and recorded stimuli output from a system (system's signal) that has been input to a transducer (measuring instrument) and recorded (with the aid of a transponder record making device).

Many different embodiments can utilize the broad concept of the present invention, but three specific embodiments are:

A. Recalibration of Meter responses
B. Recalibration of Attitudinal responses
C. Recalibration of Discomfort responses
Three Component Systems that Produce the Recorded Data

Such a system is shown in FIG. 8. The importance of explicitly noting the components that produce the recorded data is that the internal workings of each component, which can, in turn, be influenced by their external environments, can be a source of biases that might need correcting. The components can be connected in different ways e.g. by wife or by physically location. FIG. 8 topologically illustrates each of the three components producing recorded data that can be combined into differently connected configurations. Usually the internal environment of each component can be considered to be embedded in its external environment. For example, a physical meter is often physically present in the environment where it is used. So, the internal environment of a meter is often physically embedded in its external working environment. Though, alternatively, the meter can be a remote sensor which is itself controlled remotely from a different physical environment. The causal interactions between the components will be physically limited by how they are connected (e.g. direct chemical interactions require physical connection). When the components form one physical object denoted ‘+’ (e.g. embodiment B physically combines 1+2 then 3), the different forms of causal interactions that are possible (e.g. electro-chemical interactions) might have not been possible when the components are completely or partially physically separated (e.g. embodiments A and C include the combination 1 then 2+3). Under assumptions that 2 and 3 do not influence 1R, FIG. 8 can be reduced to FIG. 7a.

### Applications

The internal workings of each component and its resulting output stimuli can be perturbed by altering stimuli input to each component from its environment. The workings of each component can be investigated by the relations between the control of stimuli that perturbate the internal workings of each component and the resulting recorded data—including no, null or zero stimuli to the external environments that cause perturbations of zero and so do not affect the normal internal workings of a component. In particular, each environment for each component can have its own systematic biasing effect (E) on its throughput stimuli. This novel method uses reference stimuli as perturbations and assumed response theory(s) to (i) validate the theory(s) and/or (ii) correct for response biases in embodiments with different combinations of connections of the components.

### The Components can Physically be Separate Bodies or Physically Combined Bodies

In a first Embodiment A, components 2 and 3 are often physically combined (2+3) as a meter e.g. volt meters or amp meters, or they can be connected remotely so that the data can be recorded by a remote recording device. The meter can be used to investigate the internal workings of the System 1 (component 1) using controlled or random inputs to the external environment of System 1. Alternatively, they may be used to measure a ‘normal’ unperturbed stimulus from the System 1 e.g. normal meter reading of a wall socket voltage, under the assumption that perturbation stimuli to System 1 are zero or not influencing the meter components 2+3.

In the 2nd embodiment, the two components 1+2 are in one object (e.g. a person or other compound system/measurement object), so that the perturbation stimuli to system 1 (e.g. questions from a questionnaire) can also be expected to effect (i.e. bias) components 2 and 3 and thus the recorded data. In this case, a more nuanced Response Theory might be preferred to account for interacting biases in all three components, namely 1. System, 2. Transponder/measurement biases and 3. Recorder biases and possibly different types of interactions between them. Component 3 can also be in the external environment of 1 e.g. a questionnaire. Component 3 is used to receive the response from the person, but also has the questions that input to 1.

The only requirement is that the responses are systemic responses (i.e. assumed to be characteristic of a system). This is important because the internal and external contexts of the components used in an embodiment must be constant during gathering the responses to the reference stimuli and the unknown stimulus. This is a limitation that affects the solution of the Response Theory equation(s)—making them a set of ‘simultaneous equations’—used for the output(s) and for other claims of the patent method. There must be at least as many reference signals as unknown E parameters. That is, at least one extra reference signal must be available for calculating each extra unknown E value in the Response theories. Any appropriate software for solving simultaneous equations can be used for calculating the E parameters. There are many such methods, so giving a choice of options and assumptions for the user. More reference signals can be used for calculating the accuracy of the E values if required. However, the complete resulting Response theory equation(s) can then be used to calculate the unknown target True target stimulus or stimuli.

In general, the technical advantages of the invention are suggested by untoward changes in either or both of the internal and external environments of the systems that are combined in the producing the recorded Response for input to the invention.

When considering the recalibration of meter responses, where a physical meter is a system, one technical effect is that the invention may correct for biases of wear, so the meter needs less maintenance. The invention may also correct for biases that limit use, for example temperature extremes, so meters become usable over wider ranges and therefore a smaller inventory of meters is required.

For the meter reading embodiment, we may have one or more changes in each internal and external environment. Other untoward changes in the internal (and external) environment that can be independently detected (for automatically selecting RTs relevant to those changes) are internal over-heating, internal humidity, etc. depending on what can affect the construct being measured by the meter (voltage, radioactivity, pressure, chemical constituents, etc.). The meter may have two constituent components, a transducer (change of energy mode) and a transponder (recording the ‘strength’ of the change in a different modality e.g. from loudness of sound to a needle movement over a printed decibel scale). Each has an internal and external environment in which untoward events can be automatically monitored and their bias accommodated by selection of a relevant RT for recalibrating signals changed when crossing the boundaries between these environments. Note these are untoward changes to the signal, not simple ‘out of paper’ or ‘low on ink’ type of events that don't modify the strength of a signal response that is being used to indicate the strength of a construct being measured.

When considering the recalibration of attitudinal responses, where a person is acting as a system, one technical effect is that the invention may correct for subjective questionnaire biases, so fewer questions and respondents are needed, saving on resources, either physically or computationally, as well as reducing respondent/subject/patient burden.

Another technical effect in [0049] is that the invention can selectively increase expected bias by modifying the transducer function of the data administration environment e.g. producing compliance responses using a threatening administration e.g. conveying a high risk of error, or vice versa. Using a current example where patient satisfaction is regularly used as a proxy for successful medical treatment: A further advantage and/or technical effeect is that it is less costly for management to increase satisfaction by training staff to be more pleasant and/or educating patients to expect poor treatment (i.e. causally modifying the systemic bias of the transducer function), than it is to increase satisfaction by resourcing and training staff to increase the success of medical treatments by becoming more competent and skilled practitioners. These changes in R resulting from changes in responder expectations are known as ‘response-shifts’. The invention can identify and measure all types of response-shifts. It does this by using the same objective reference gold-standard public object for recalibrating pre and post response-shift measures. This is a surprising result that has not been possible using previous designs.

Similarly, expectations can be modified at the transponder/recording stage by selecting threatening high difficulty response formats and vice versa.

A highly valuable technical effect of the invention is to identify and measure these changes in expectation as being responsible for the increased patient/customer/civilian satisfaction rather than the claimed increase in quality services as being responsible. This is an excellent policing technique for regulators e.g. the FDA who have legalized the ‘clinical authority’ of customer endorsements of medical devices.

When considering the recalibration of discomfort responses, where a person is acting as a system, one technical effect is that the invention may remove subjective bias. One example is when doctors commonly ask ‘how painful is it on a scale from 1 to 10?’. The invention removes subjective bias so that the resulting objective pain ratings can be compared across patients, and across groups of patients, thereby providing more accurate information and allowing more efficient treatment. Where there are many such ‘pain gauges’ in operation one technical effect is to collate their information in the cloud as an objective pain database for objectively comparing pain experiences of patients in the same demographic groups and comparing pain expectations across groups (e.g. the English are said to be more stoic than the Italians and women more stoic than men). The cloud database can objectively evidence policy on pain management and policy decisions.

### Scaling Attitudinal Response Data

The problem with accuracy in attitudinal questionnaires stems in large part from a concept known as expectation. Different persons may rate similar strengths of a construct drastically differently based on many unquantifiable factors, such as cultural background, past experiences, present emotional state, etc. The bias generated by these unquantifiable factors can be referred to as the respondent's expectation.

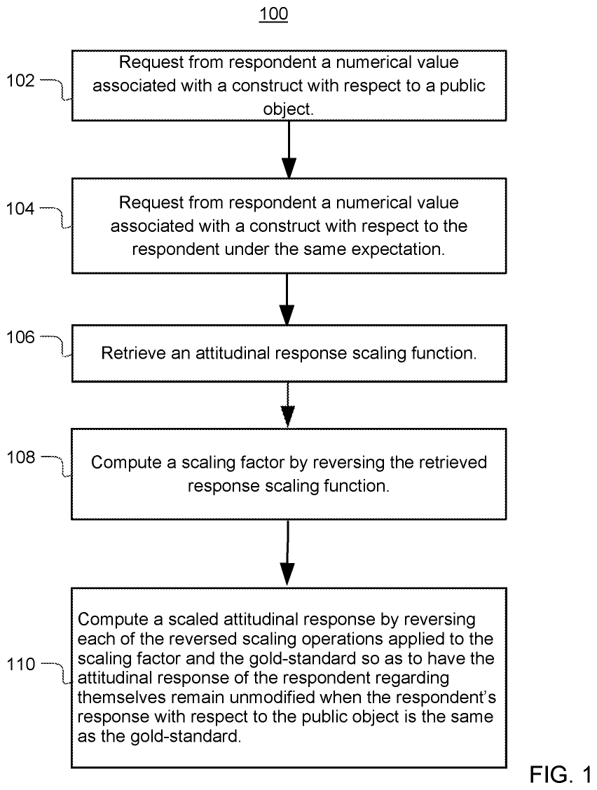

FIG. 1 shows a flow diagram illustrating a method 100 of collecting and scaling attitudinal questionnaire data to account for respondent expectation, according to particular example embodiments. This process may be performed by any suitable systems, software, and/or human activity, or any combination thereof. In particular embodiments, method 100 is performed by processing logic that can comprise hardware (e.g., circuitry, dedicated logic, programmable logic, microcode, etc.), software (e.g., instructions run on a processing device), or a combination thereof. Whilst this and other examples includes steps relating to obtaining, collecting or otherwise acquiring the data, the broadest aspect of the invention does not require these steps, but can be applied to data which has already been collected and recorded in some form.

Initially, at step 102, a respondent is asked to assign a numerical value to a construct with respect to a public object. A construct as used herein may be any observable quantity or concept. For example, the construct may be a feeling of discomfort or pain that a patient is experiencing. A construct can also be a socio-cultural identity named from one or more behaviors and/or states, such as a teacher, musician, consumer, schizophrenic, victim etc. A public object may be an observable expression of the construct for which the true value (or gold-standard) is known. It is called a ‘public object’ because all respondents and observers (i.e. the ‘public’) have equal access to it as a singular objective reference stimulus for their subjective representations of it. This contrasts with a ‘private object’ for which there is no single common objective reference stimulus, which is necessary for guarantying that all subjective representations do not vary because of the stimulus but because of the observers' interactions with the stimulus. For example, a respondent may be shown a video of a person walking comfortably on a treadmill and asked to rate that comfortable walking speed of the person. The questionnaire designers know the true walking speed of the videoed person, (e.g., 5 km/hr). The construct in this example is ‘comfortable walking speed’, and the videoed person is the public object reference for which the gold-standard walking speed is 5 km/h.

At step 104, after providing a response with respect to the public object the respondent is asked to assign a numerical value to the construct with respect to themselves under the same expectation. For example, the respondent is asked to rate their own comfortable walking speed. While a person may have a poor concept of walking speed (i.e., an unreasonable expectation), the person may still have a good idea of how their own walking speed compares to that of the public object. However, the questions in steps 102 and 104 may be asked in a manner that maintains the same expectation. For example, the second questions may be asked immediately after the respondent responds to the first question. By asking the respondent to rate the construct after rating a public object, the method results in the collection of two distinct values under the same expectation. In an example, the respondent answers 4 mph as the speed of the videoed person, and 2 mph as their own speed. Note that the speed units used by the respondent and the gold-standard may be different (i.e., mph vs. km/h).

At step 106, an attitudinal response scaling function is retrieved. The attitudinal response scaling function may be any one of certain functions where the respondent expectation directly influences the response scaling (as opposed to via an error term). Generally speaking, an attitudinal response scaling function would have the form of R=f(T,E,e), where R is the user provided response, T is the desired true value of the response, E is the respondent's expectation, and e is an error term. By way of example and not limitation, theoretical attitudinal response scaling functions may be: R=(T×E)+e; R=(T^{E})+e, etc, but not R=(T+E)+e, etc. when units are changed between systems.

At step 108, a scaling factor is computed by reversing the retrieved response scaling function. Continuing the above example, a respondent may have given an answer of R₁=2 mph as their own comfortable walking speed, and an answer of R₂=4 mph as the public object (i.e., videoed person) comfortable walking speed. If the retrieved response scaling function is R=(T×E)+e, then we can apply the functions as R₁=(T₁×E)+e and R₂=(T₂×E)+e, since the respondent expectation has been maintained the same, as explained above. Since E acts on T via multiplication, step 108 reverses and combines the multiplication operations by applying division to the response values, which yields an attitudinal scaling factor of: R₁/R₂=(T₁×E)/(T₂×E)=T₁/T₂=2 mph/4 mph=0.5. From T₁/T₂=0.5 we can appreciate the objective result that the respondent walks at 0.5 times the speed of the public object. Note that in the above example the mph units cancel out when performing the division. Because the expectation units cancelled, the scaling factor is independent of the expectation value and can be used in method 100. If the expectation units did not cancel out when reversing the function, then such a function could not be scaled in this manner.

At step 110, a scaled attitudinal response is computed by reversing each of the reversed scaling and combining operations applied to the scaling factor and the gold-standard so as to have the attitudinal response of the respondent regarding themselves remain unmodified when the respondent's response with respect to the public object is the same as the gold-standard (i.e., the gold-standard and R₂ cancel out). In the above example, Rs₁=(R₁/R₂)×G, where Rs₁ is the scaled attitudinal response to the respondent's comfortable walking speed and G is the gold standard. In the above example, Rs₁=0.5(5 km/hr)=2.5 km/hr.

In general, the scaling factor may be calculated using a preferred function for solving simultaneous equations. Reversal, as in this specific example, is only a condition required where there is a change in expectation in the recording (transponder) system such as, for example, in the attitudinal scale embodiment where the response is in different units than the gold-standard. The responder is using the researcher's expectations, but the respondent is using their own expectations. This condition requires the recognition of the two expectations and therefore an extra reference reading would be needed to calculate the extra unknown expectation. However, this extra reference reading can be avoided by limiting the response theories to identity functions i.e. f⁻¹(f(T, E, e))=1.

The accuracy of the scaled attitudinal response may be assessed using a biomarker, i.e., an independent measurement that reveals the actual value of the construct with respect to the respondent. As an example, respondent can be asked to walk and their comfortable walking speed measured (e.g., the measured time to walk 5 meters). This biomarker can then be used to assess the accuracy of the method of scaling attitudinal response data by, for example, determining whether the scaled response or the respondent's value correlate closer to the biomarker. To continue the above example, assume the respondents comfortable walking speed is measured and this biomarker is found to be 2 km/h. The percentage of error of the scaled attitudinal response would be given by Error Rs₁=|B−Rs₁|/B, where B is the biomarker. In the example, Error Rs₁=|2 km/hr−2.5 km/hr|/2 km/h=25%. Likewise, percentage of error of the respondent's response would be given by Error R₁=|B−R₁|/B. In this example, Error R₁=|2 km/h−3.22 km/h|/2 km/h=60.93% (note that 2 mph≈3.22 km/h). In this scenario, the scaled attitudinal response provides a more accurate datum than the user response.

Whilst the above discusses biomarkers in relation to medical application, in opinion surveys, the accuracy may be assessed using a public reference stimulus of knowable numerical value e.g. a picture or a vignette that all respondents could read whose value would be assessed by consensus of a demographic group—this is known as an Angoff assessment. This assessment using a public reference stimulus of knowable numerical value is very important because great problems are being caused, particularly in medicine, because so called experts in a given field claim there is no gold-standard for many medical constructs that they measure. This makes the accuracy of questionnaire instruments (known as ‘Patient Reported Outcome Measures PROMS) at best extremely unclear. There are currently tens-of-thousands of these subjective medical questionnaires, that have low or no (even negative) accuracy, being used to make hundreds-of-thousands of life-or-death decisions on patients' health.

As previously mentioned, the attitudinal response scaling function may be any suitable function where the respondent expectation directly influences the response scaling. In another example, the attitudinal response scaling function may be R=(T^{E})+e. In this example, since E acts on T as an exponential, step 108 reverses this function using a logarithm, which yields:

ln=ln(T₁E)=E×ln(T₁)

ln R₂=ln(T₂E)=E×ln(T₂)

ln R₁/ln R₂=ln(T₁)/ln(T₂)

ln R₁/ln R₂=ln 2 mph/ln 4 mph=0.6931/1.3863=0.5

Again, the mph units cancel out indicating that the R=(T^{E})+e function can be scaled using method 100. Again, at step 110, a scaled attitudinal response is computed by reversing each of the reversed scaling operations as applied to the scaling factor and the gold-standard so as to have the attitudinal response of the respondent regarding themselves remain unmodified when the respondent's response with respect to the public object is the same as the gold-standard (i.e., the gold-standard and R₂ cancel out). In this case:

Rs₁=exp{ln(R₁)/ln(R₂)×ln(G)}

Rs₁=exp{0.5×ln(5) km/hr}

Rs₁=exp{0.5×1.6094 km/hr}

∴Rs₁=exp(0.8047 km/hr)=2.2361 km/hr

Identifying Sub-Construct Groups from System Response Outcome Data

Collected response outcome data may be used to discover characteristics, profiles, or signatures of the systems that produced them. Identifying sub-construct groups can help uncover and measure ancillary facilitating or inhibiting influences on the strength of construct endorsement by a respondent. This can be accomplished using clustering or unsupervised learning techniques that can identify system categories/species/subspecies from the data. Defining the boundaries of these categories (or clusters) can provide useful insight into, and measurements of, characteristics, profiles or signatures (CPS) of one or more systems that produced the outcomes. Future data can then be classified into these categories as deemed appropriate. As an example, questionnaire responses related to disease symptoms in patients may be analyzed in an effort to diagnose future patients using the questions related to their symptoms. Data from prior responses may be used to assess the probability of having the disease or the advancement of the disease in a new patient based on the similarity of their CPS scores to the CPS scores of the target diseases.

One problem in identifying sub-construct groups from system response outcomes is that many scales use the strength with which respondents endorse questions to indicate both the strength of the respondent's memberships of the construct category and the strength of the experience of the construct. For example, COSs for disease or disorders score the strength with which symptoms are endorsed to indicate both the certainty of having the disease/disorder (membership of disease category/construct) and degree of severity of the disease/disorder (disease burden), interchangeably. However, it is possible, and even common in the early stages of disease, to be certain of having the disease (strong construct membership) while only experiencing mild symptoms (weak construct experience). Similarly, strong symptom endorsement might not indicate construct membership if the strong symptom experience were shared with another disease or independent lifestyle.

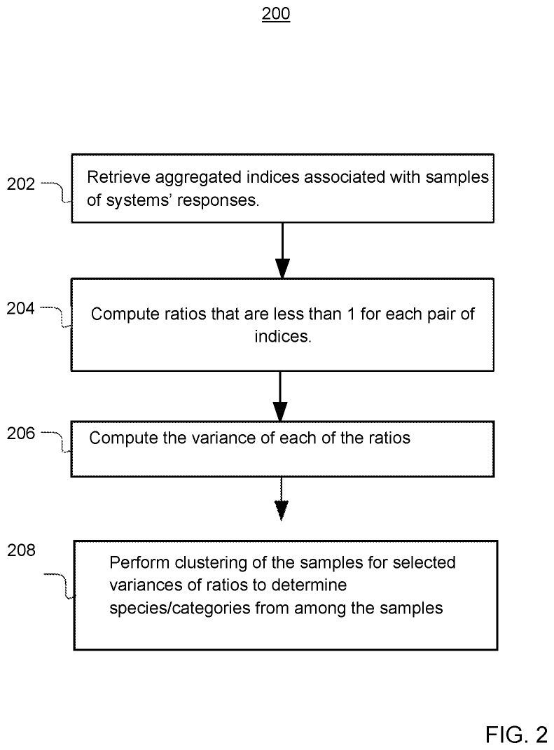

FIG. 2 shows a flowchart for a method 200 for identifying sub-construct groups from system response outcome data, according to particular example embodiments. This process may be performed by any suitable systems, software, and/or human activity, or any combination thereof. In particular embodiments, method 200 is performed by processing logic that can comprise hardware (e.g., circuitry, dedicated logic, programmable logic, microcode, etc.), software (e.g., instructions run on a processing device), or a combination thereof.

At step 202, system outcome data is retrieved. In particular embodiments, the data may be organized as a matrix of vectors. In particular embodiments, the data relates to paired responses and each vector holds the same-ordered outputs for all paired responses for each respondent. As an example, each vector in the matrix may hold a response to a first question with respect to a public object, a response to the first question with respect to the respondent, a response to a second question with respect to a public object, a response to the second question with respect to the respondent, etc.

At step 202, aggregated data associated with attitudinal responses is retrieved. As an example, patient response data to a questionnaire is obtained, and the average of the responses to each question is computed. In particular embodiments, the data may be organized as a matrix of vectors, where each vector holds the same-ordered outputs for all paired responses for each respondent. The use of attitudinal response here is merely indicative of the sort of data that could be used. The technique could be applied to any suitable system response, including those specifically discussed in this application.

In particular embodiments, factors including using statistical factor analysis may be generated using combinations of other responses of the system as dictated by a preferred formula for combining them including using statistical factor analysis. As an example, a varimax rotate can be used to determine one or more principal components of the data space, i.e., components orthogonal and independent of each other. The obtained factors may then be averaged across all respondents.

Once factors have been retrieved, at step 204, ratios that are less than 1 for each pair of factors are computed. As an example, if four factors V1, V2, V3, and V4 were obtained in step 204, then all combination of ratios (V1,V2), (V1,V3) (V3,V4) are compared, and for each pair the ratio of the lesser value to the greater value is computed. If V2 is greater than V1, then the (V1,V2) ratio is computed as V1/V2. In this manner, the ratios remain small for ease of analysis. In certain situations, such as making decisions about medical treatment, the time taken for the analysis to be carried out can be of significant importance as time elapsed prior to treatment can be a critical factor that affects the likely outcome of that treatment. For example, it is well known that providing certain treatments within a set time period of a patient having a stroke can greatly affect the success or otherwise of reversing the effect of the stroke on the patient. As such, rapid analysis, which can lead to real time results being achieved and therefore real time decisions being taken, can be an important factor in this or any other of the methods described in the application.

At step 206, the variance of each of the ratios selected in step 204 is computed. At step 208, the ratio having the lowest variance is determined. This minimum variance ratio (MVR) serves as a main construct signature. The MVR provides a relationship between two factors that has the least variability among respondents, indicating that this ratio is a marker of the construct that can be used to detect and measure anomalies (e.g., diseases). In the current general form, this ratio is an identity marker (the CPS) of the system (or combination of systems) that produced the signals. That is the principle underlying the MVR. In this example the systems producing the responses are diseases and the responses that are produced are symptoms. Comorbid diseases have symptoms in common. This CPS marker can now be used to separate out the separate diseases. Or if it is only one disease, it can be used to separate out species of the disease like mutant strains of the COVID virus. One way that can be done is using cluster analysis (e.g. global or local hierarchal centroid cluster analysis—the worked example uses the global version. Doing it in reverse by retesting at each bifurcation, is the local version which is a preferred option to compare with the global version).

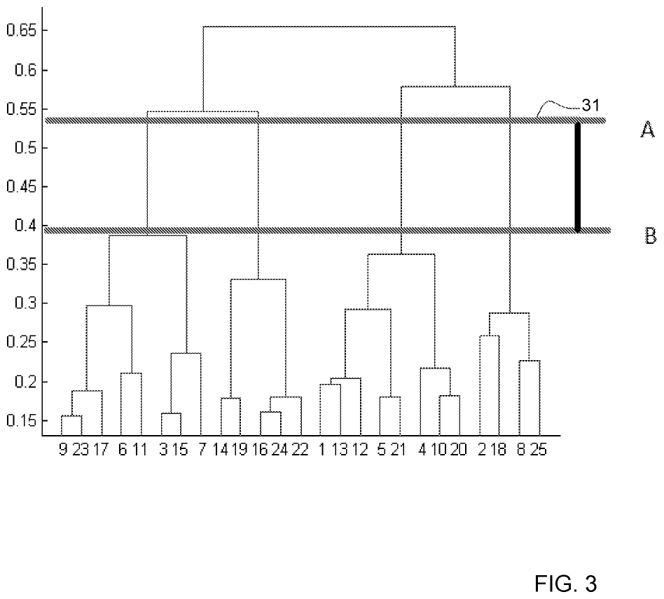

At step 208, the respondent's MVRs are clustered to determine species/categories from among the respondents. Clustering may be performed using any suitable type of clustering e.g. local or global, and using any suitable clustering technique and metric e.g., centroid clustering, distribution-based clustering, density-based clustering, K-means clustering, mean-shift clustering, etc. As an example, centroid clustering of the MVRs may be performed using hierarchical clustering, as illustrated in the dendrogram 300 shown in FIG. 3. Dendrogram 300 shows every data point in the x-axis assigned to a separate cluster, i.e., 25 points in FIG. 3. Every cluster is then merged into a new cluster with its closest neighbor in the data space, until there is only one cluster left (this global clustering moves from bottom to top in the graph). The x-axis represents the distances between two clusters in the data space. To determine the number of clusters, a horizontal line 310 is determined that can transverse the maximum distance vertically without intersecting a cluster. The number of vertical lines crossed by this line 310 is the number of clusters, e.g., 4 in the example of FIG. 3. In this manner, sub-construct groups may be identified that can be useful for identifying construct membership of respondents.

The result of method 200 should be a plurality of species are identified. These species may vary in purity (i.e., similarity/difference) and in the number of respondents in each species. One of more of the species may be empirically selected as a main emic construct group, i.e., the group that best characterizes the system. For example, this main group may be identified as the group that maximizes the number of respondents while minimizing differences, i.e., the lowest ratio of number of respondents vs. differences. Furthermore, the species or sub-species, once identified, can be compared on demographic or other “exposome” lifestyle variable to research inhibiting and enhancing influences on how strongly respondents endorse the defining construct experiences. The “exposome” variables can then be added to the dataset and the MVR repeated to give greater purity of differentiation between species and subspecies.

Method 200 may be applied to any system suitable for clustering analysis, such as, by way of example, medical diagnosis via questionnaires, psychological evaluations, medical core outcome sets, etc. In one example, method 200 may be applied to determining whether patient's have a particular disease based on questionnaire responses. In this scenario, the disease is the system under study and the symptoms are the response outcomes. One way (a previous design for) of identifying the disease and/or its strength is to gather responses from a group of patients and averaging them. These averages can then be used to generate tables that map value ranges to disease diagnosis or severity in order to diagnose future patients based on their own responses. However, these methods (previous designs) rely on the strength with which respondents endorse their answer/symptoms and do a poor job at accounting for and removing error. In contrast the MVR method is 100s to 1000s of times more sensitive using responses to percentage precision (e.g. on a scale from 1 to 100).

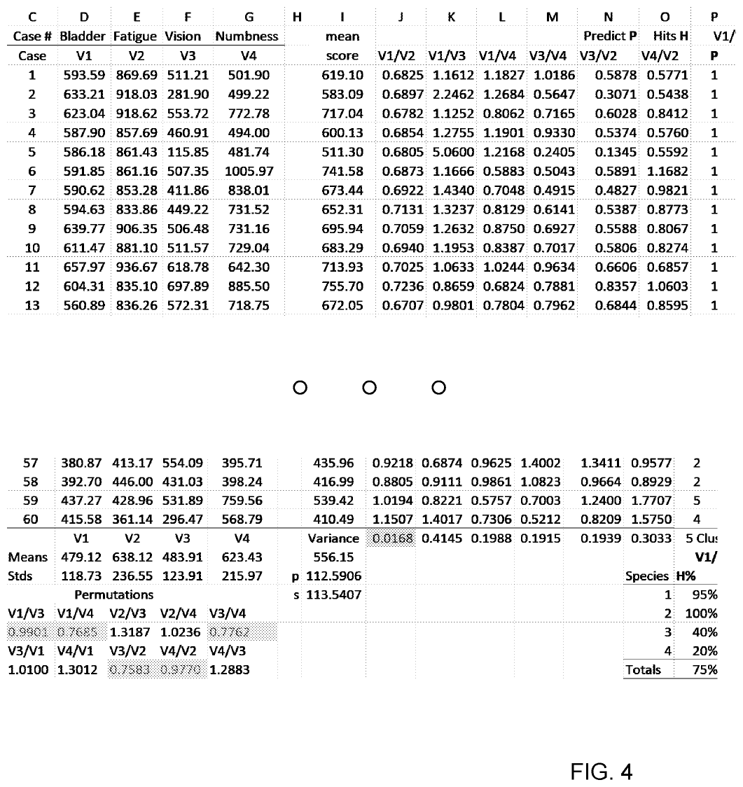

As one example of an application of method 200, respondents may be asked four questions meant to screen for diabetes. The questions may ask each respondent to state the extent to which they have experienced each of the following symptoms over the last month on a scale from 0 to 1000: (V1) weakness or fatigue, (V2) bladder issues, (V3) vision problems, and (V4) tingling and numbness. FIG. 4 shows sample results for 60 patient responses. As explained with respect to method 200, the answers of the 60 respondents are averaged, yielding four values: 479, 638, 483, 623. Then the lowest ratio among each pair of question is computed and the ones that are less than 1 are identified, in this case V1/V2, V1/V3, V1/V4, V2/V3, V2/V4, and V3/V4. The variance these ratios for the 60 questions is computed, and the smallest is identified, in this case the variance of V1/V2=0.0168. As such, the ratio of fatigue over bladder issues is identified as the key diagnoses marker for diabetes that can be used to detect and accurately measure a patient's progression in the disease.

To accomplish this, the variances of V1/V2 for each respondent are clustered, and each respondent is assigned to a cluster. In this example, using global hierarchical clustering yields 5 clusters, and each patient is assigned to one the clusters 1 through 5, as shown in column P of the table. Each one of these clusters may represent distinct variants of these symptoms of the diabetes disease. By correlating this data with other indicators of diabetes, e.g., blood tests, each of these clusters can be associated with a particular diagnosis of the presence, stage, progression or severity of the disease. As such, future patients that are screened for diabetes with the same questionnaire may be quickly diagnosed with high accuracy based on their responses, increasing the rate of detection and providing earlier detection of diseases.

Furthermore, in the medical diagnosis scenario, other diseases may have symptoms that overlap with a particular disease. For example, diabetes shares symptoms with multiple sclerosis, stroke, glaucoma, glucagonoma, and Graves' disease, among others. Thus, a misdiagnosis can be serious or even fatal. By repeating the above method for each disease, a profile of V1/V2 for each disease may also be obtained, allowing precise diagnoses to be made with attitudinal questions or with biomarkers of the symptoms.

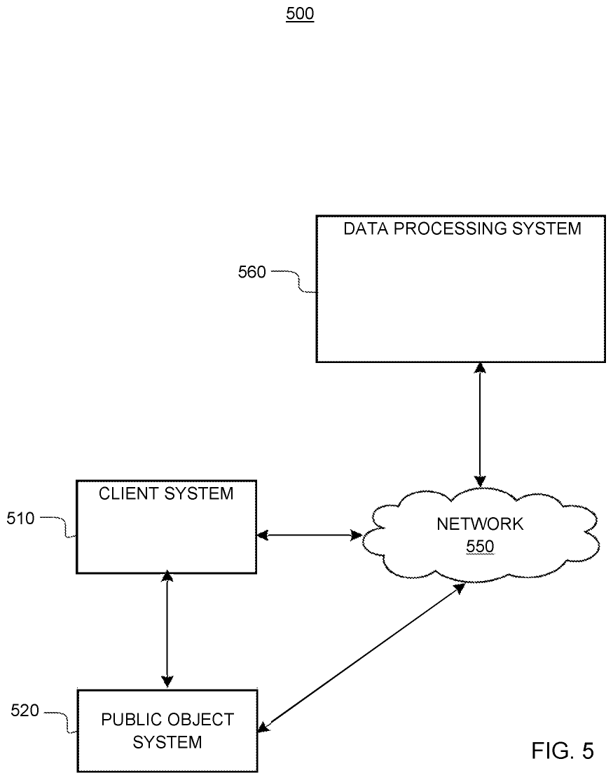

FIG. 5 illustrates a questionnaire system environment 500, according to particular example embodiments. While system 500 provides an example of a computerized system for collecting, scaling, and analyzing attitudinal questionnaire data to account for respondent expectation, it should be understood that the invention is not limited to the embodiments described herein, computerized or otherwise.

In particular embodiments, a client system 510 communicates with a data processing system 560. Client system 510 may be any computing device suitable for retrieving attitudinal responses, such as, by way of example, a personal computer, mobile computer, laptop computer, mobile phone, smartphone, personal digital assistant, or tablet computer. Data processing system 560 may be any computing device or combination of devices suitable to receive and process attitudinal responses, such as, by way of example, server computers, database systems, storage area networks, web servers, application servers, or any combination thereof.

In particular embodiments, client system 510 and data processing system 560 communicate through a network 550. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, or any combination thereof. In other embodiments, client system 510 and data processing system 560 may communicate directly through a peripheral connection. In other embodiments, client system 510 and data processing system 560 may be embodied in a single device, e.g., within a single computer system and/or application.

It is possible to use the MVR process to identify the optimum reference system for the BCD process as described in the following. The link between MVR and BCD is that the MVR process can be used to identify the optimum reference system used by the BCD process. The advantage in doing this is that the BCD process identifies, measures and manages the systemic expectation in the data. However, the quality of his process is dependent on the relevance of the reference system used by the BCD process. The MVR identifies the most relevant system. Thus the structure of systems producing data for MRV can be described in the same terms as the structure of systems producing data for BCD i.e. sentient objects whose signals qualify them as ‘fit for purpose’ see [0038] and [0080]

To define ‘relevance’, we can consider from the ‘sentient being’ perspective that relevance means that the reference system shares our attitudes, beliefs intentions purposes and values. In the attitudinal questionnaire embodiment, for the reference to be relevant the respondent must share the same construct as depicted in the reference picture or vignette e.g. if the respondent is asked about his/her diabetes, then the public object reference should present diabetes in a way that the respondent can identify with, ideally be just like the respondent's situation. In the mobility example, the person walking at a known comfortable speed should be just like the respondent, walking in a typical environment that the respondent would be walking at a comfortable speed—so the respondent can easily ‘feel’ it is they who are walking in the reference situation. In the metering embodiment, say measuring the current from a wall socket, the reference current used for the BCD recalibration of the wall socket current should be of the same order, ideally the same as, the current from the wall socket.

A user of client system 510 receive attitudinal questions and input responses through any suitable graphical user interface, such as, by way of example, an application, web browser, web application, mobile application, etc. In particular embodiments, a public object system 520 provides a public object for the user to answer attitudinal questions with respect to a public object, acting as the gold-standard reference signal in the BCD process as described above. Client system 510 and/or data processing system 560 may communicate with public object system 520 provide or receive public object data. Public object system 520 may be embodied on a separate device and communicate via, for example, network 550, a different network, or a peripheral connection, or embodied in a single device, e.g., within a single computer system and/or application. In particular embodiments, clients system 510, public object system 520, and data processing 560 are implemented in a single device such as, for example, a personal computer using peripherals for the various functionalities described herein (e.g., display device, input/output devices such a display, mouse, and keyboard, and peripherals for providing a public object such as an electric shock device).

Public object system 520 may include any suitable interfaces for providing a public object. As an example, public object system 520 may provide a video, audio, or other multimedia experience (e.g., video of a person walking on a treadmill). In another example, public object system 520 may include a device that provides pain events are public object stimuli from which gold-standards can be obtained, such as standard placement of electric shocks, pressure clamps, thermal pads, etc. It should be understood that public object system 520 may provide any suitable public object experience aptly relevant for attitudinal evaluation of the construct(s) being measured.

As an example, public object system 520 may be used to apply to a patient a half-second 3 milliamp electric shock by pressing two contact buttons on the device with their index fingers. A respondent/patient may be asked to rate the physical discomfort caused by this public object experience on a scale from 1-100. To maintain the same expectation, as described above with reference to method 100, the respondent may be asked to rate the discomfort caused by their own pain from their condition/disease on the same scale. Other forms of physical discomfort could include loud noise, bright lights, pressure squeeze, hot or cold stimulus, vile taste or tugging with a weight on the ear.

The respondent's answers are input into the client device 510, and are sent to data processing device 560 for processing according the methods 100 and 200 described above. In the pain measurement example, a gold-standard pain for the public object discomfort can be computed by averaging the pain ratings from multiple patients/respondents as the consensus pain caused by the public object device.

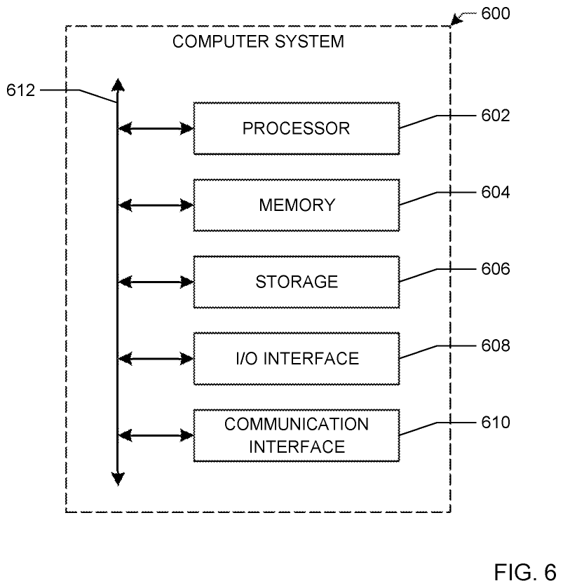

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example, computer system 600 may be an embedded computer system, a desktop computer system, a laptop or notebook computer system, a mainframe, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, memory 604 includes random access memory (RAM). This RAM may be volatile memory, where appropriate Memory 604 may include one or more memories 604, where appropriate. Although this disclosure describes and illustrates particular memory, this disclosure contemplates any suitable memory.

In particular embodiments, storage 606 includes mass storage for data or instructions. As an example, storage 606 may include a hard disk drive (HDD), a USB flash drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example, bus 612 may include an PCI Express (PCIe) or other graphics bus, QuickPath Interconnect (QPI), a HYPERTRANSPORT (HT) interconnect, an INFINIBAND interconnect, anEnhanced Serial Peripheral Interface Bus (eSPI), a memory bus, a serial advanced technology attachment (SATA) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, USB flash drives, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

The breadth and scope of the invention should not be limited by any of the above-described exemplary embodiments, but should be defined only in accordance with the following claims and their equivalents.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

1. A method for recalibrating a system signal to identify, measure, and/or manage systemic bias, the method comprising:
(a) define context appropriate response theories that partition systemic error ‘E’ differently from random error ‘e’, described as R=f(T, E, e), where ‘E’ is system expectation bias and ‘e’ is a random error;
(b) measure one or more reference responses within a set context where the ‘E’ values are constant using at least as many reference signals as there are unknown E values,
(c) input a target signal to be recalibrated,
(d) determine, using the responses to the reference signals, the ‘E’ values giving a formula for calculating R in the set context,
(e) determine the most appropriate response theories from a selection of given response theories, and
(f) recalibrate the target signal using the selected response theory.

2. The method according to claim 1, wherein the method is implemented on a computer having at least one processor.

3. The method according to claim 1, wherein the response theory is a function comprising at least one of: a multiplication or division operation, an exponent or logarithmic operation, or simultaneous equations.

4. The method according to claim 1, wherein the set context comprises a presentation of a stimulus comprising at least one of an image, a video, an audio, a text, a smell, a taste, and a feeling.

5. The method according to claim 1, wherein the set context comprises a presentation of a vignette, a celebrity, a personification, or a brand image.

6. The method according to claim 1, wherein the set context comprises a standard stimulus applied to the respondent.

7. The method according to claim 1, wherein, in step (a), R represents a Response signal recorded by a computer, T represents the True unbiased component of the signal as sent by the source system(s) and f is a function describing how each of these three components of the Recorded signal have been elaborated and combined to result in the recorded response signal R.

8. The method according to claim 1, further comprising, in step (b), determining the most appropriate response theory(s) from a selection of given response theories.

9. The method according to claim 1, further comprising, in step (c), receiving Recorded response(s) R that correspond to one or more known perturbative true reference signals T within a set context where the ‘E’ values are constant, using at least as many reference signals as there are unknown E values in the most appropriate response theory(s) from step (b).

10. The method according to claim 1, further comprising, in step (d), receiving a Record of the response to an unknown perturbative target signal T within the same set context where the ‘E’ values are constant.

11. The method according to claim 1, further comprising, in step (e), determining the ‘E’ values giving a formula or formulae for calculating R in the set context, for the most appropriate response theory(s) from step (b), using the responses from step (c) to the reference signals.

12. The method according to claim 1, further comprising, in step (f), recalibrating the response from step (d), using the formula or formulae for calculating R in the set context from step (e), to calculate/reveal the true value of the previously unknown perturbative target signal T received in step (d).

13. The method according to claim 1, further comprising repeating step (d) using the same perturbative target signal T in the set context, to use the variation in the corresponding R values and/or corresponding recalibrated values from (f) to check the consistency of the context where the ‘E’ values are required to be constant.

14. A system, comprising:
a memory and at least one processor coupled to the memory and configured to:
(a) define context appropriate response theories that partition systemic error ‘E’ differently from random error ‘e’, described as R=f(T, E, e), where ‘E’ is system expectation bias and ‘e’ is a random error;
(b) measure one or more reference responses within a set context where the ‘E’ values are constant using at least as many reference signals as there are unknown E values,
(c) input a target signal to be recalibrated,
(d) determine, using the responses to the reference signals, the ‘E’ values giving a formula for calculating R in the set context,
(e) determine the most appropriate response theories from a selection of given response theories, and
(f) recalibrate the target signal using the selected response theory.

15. The system according to claim 14, wherein the response theory is a function comprising at least one of: a multiplication or division operation, an exponent or logarithmic operation, or simultaneous equations.

16. A tangible computer-readable device having instructions stored thereon that, when executed by at least one computing device, causes the at least one computing device to perform operations comprising:
(a) define context appropriate response theories that partition systemic error ‘E’ differently from random error ‘e’, described as R=f(T, E, e), where ‘E’ is system expectation bias and ‘e’ is a random error;
(b) measure one or more reference responses within a set context where the ‘E’ values are constant using at least as many reference signals as there are unknown E values,
(c) input a target signal to be recalibrated,
(d) determine, using the responses to the reference signals, the ‘E’ values giving a formula for calculating R in the set context,
(e) determine the most appropriate response theories from a selection of given response theories, and
(f) recalibrate the target signal using the selected response theory.

17. The tangible computer-readable device according to claim 16, wherein the response theory is a function comprising at least one of: a multiplication or division operation, an exponent or logarithmic operation, or simultaneous equations.

18. The system according to claim 14, wherein the set context comprises a presentation of a stimulus comprising at least one of an image, a video, an audio, a text, a smell, a taste, and a feeling, or a presentation of a vignette, a celebrity, a personification, or a brand image, or a standard stimulus applied to the respondent.

19. The system according to claim 14, wherein, in step (a), R represents a Response signal recorded by a computer, T represents the True unbiased component of the signal as sent by the source system(s) and f is a function describing how each of these three components of the Recorded signal have been elaborated and combined to result in the recorded response signal R.

20. The tangible computer-readable device according to claim 16, wherein the set context comprises a presentation of a stimulus comprising at least one of an image, a video, an audio, a text, a smell, a taste, and a feeling, or a presentation of a vignette, a celebrity, a personification, or a brand image, or a standard stimulus applied to the respondent.

21.-58. (canceled)
